(19) United States
(12) Patent Application Publication
(10) Pub. No.: US 2024/0169270 A1
(43) Pub. Date: May 23, 2024

(54) MODEL TRAINING METHOD AND APPARATUS, ELECTRONIC DEVICE AND STORAGE MEDIUM

(71) Applicant: Douyin Vision Co., Ltd., Beijing (CN)

(72) Inventors: Peixuan HE, Beijing (CN); Yu LIN, Beijing (CN); Weili WANG, Beijing (CN); Yao ZHANG, Beijing (CN); Ye WU, Beijing (CN)

(21) Appl. No.: 18/512,713

(22) Filed: Nov. 17, 2023

(30) Foreign Application Priority Data
Nov. 17, 2022 (CN) 202211441517.5

(51) Int. Cl. G06N 20/00; G06F 21/53

(52) U.S. Cl. CPC G06N 20/00; G06F 21/53; G06F 2221/033

(57) ABSTRACT

The present disclosure provides a model training method; and the model training method includes: by a host process, acquiring training data, and dividing the training data for a training node cluster employing a master-workers architecture to obtain multiple pieces of sub-training data; wherein the training node cluster comprises a master node and multiple worker nodes; wherein the host process runs in a non-trusted execution environment, and the training node cluster runs in a trusted execution environment; by the host process, encrypting each piece of sub-training data, and storing the encrypted sub-training data in a shared memory of the host process; and controlling the master node and each of the worker nodes to acquire corresponding encrypted sub-training data from the shared memory in accordance with corresponding data storage addresses, respectively, and train a preset model by using corresponding respective decrypted sub-training data, respectively, to obtain a trained model.

### CROSS-REFERENCE TO RELATED APPLICATIONS

The present disclosure is based on and claims priority to China Patent Application No. 202211441517.5 filed on Nov. 17, 2022 and entitled as “ model training method and apparatus, electronic device and storage medium”, the disclosure of which is incorporated by reference herein in its entirety.

### TECHNICAL FIELD

The present disclosure relates to the technical field of Artificial Intelligence (AI), and in particular, to a model training method and apparatus, an electronic device and a storage medium.

### BACKGROUND

Machine learning (Artificial Intelligence, AI) employs a large amount of training data, and then applies the result obtained through learning to the subsequent decision/prediction of data, and is widely used in various scenarios, such as computer vision, automatic driving, and the like.

### SUMMARY

Embodiments of the present disclosure provide a model training method, which comprises:
by a host process, acquiring training data, and dividing the training data for a training node cluster employing a master-workers architecture to obtain multiple pieces of sub-training data; wherein the training node cluster comprises a master node and multiple worker nodes, which are used for performing model training in a collaborative manner; wherein the host process runs in a non-trusted execution environment, and the training node cluster runs in a trusted execution environment;
by the host process, encrypting each piece of sub-training data, and storing the encrypted sub-training data in a shared memory of the host process; wherein the shared memory of the host process is used for being shared by the host process and the training node cluster;
by the host process, recording a data storage address of each piece of the encrypted sub-training data in the shared memory, and transmitting respective data storage addresses to corresponding master node and worker nodes, respectively; wherein each data storage address corresponds to one training node;
controlling the master node and each of the worker nodes to acquire corresponding encrypted sub-training data from the shared memory in accordance with corresponding data storage addresses, respectively, and to decrypt the encrypted sub-training data to obtain decrypted sub-training data; and
controlling the master node and each of the worker nodes to train a preset model by using corresponding respective decrypted sub-training data, respectively, to obtain a trained model; wherein during the training process, the master node is used for transmitting a training task to each of the worker nodes and for gathering sub-training results transmitted by the worker nodes.

In the embodiments of the present disclosure, by training the model in a collaborative manner by the training node cluster employing the distributed master-workers architecture, the originally large training data can be divided into multiple pieces of small training data, so that the activation and operation efficiency of each training node can be improved. Further, by storing the encrypted training data in the shared memory area by the host process, different training nodes can read and write the shared memory area. That is, each training node can directly perform decryption operation on the shared memory, and place a decryption result in the training node, so that original ecall overhead and copying overhead of encrypted data can be omitted and the training efficiency of the model can be further improved.

In a possible implementation, after obtaining the multiple pieces of sub-training data corresponding to a number of the training nodes, the method further comprises:
by the host process, activating the master node and each of the worker nodes, and controlling the master node and each of the worker nodes to generate, in accordance with a size of data volume of corresponding sub-training data, a trusted memory matched with the data volume, wherein the trusted memory is used for storing the sub-training data.

In the embodiments of the disclosure, the corresponding trusted memory can be generated adaptively in accordance with the size of data volume of the sub-training data, so that the activation efficiency of each training node can be further improved.

In a possible implementation, the preset model is configured on the master node and each of the worker nodes, respectively; and the controlling the master node and each of the worker nodes to train a preset model by using corresponding respective decrypted sub-training data, respectively, to obtain a trained model comprises:
controlling the master node to assign a corresponding training task to each of the worker nodes based on the decrypted sub-training data corresponding to each of the worker nodes, and controlling the master node to transmit each training task to a corresponding worker node;
controlling each of the worker nodes to train the preset model in accordance with a corresponding training task and corresponding decrypted sub-training data to obtain a corresponding sub-training result;
controlling each of the worker nodes to transmit the corresponding sub-training result to the master node;
controlling the master node to gather the sub-training result of the master node and the sub-training results of the worker nodes to obtain a total training result; and
repeating the above steps until the total training result meets a preset condition.

In the embodiments of the present disclosure, since the training node cluster includes the master node and the multiple worker nodes, and the master node participates in the training synchronously under the premise of being in charge of the entire training logic, the integrity of model training can be improved on the premise of ensuring the training efficiency.

In a possible implementation, the method further comprises:
by the host process, creating a target number of queues based on the number of the worker nodes, wherein the target number is twice the number of the worker nodes; wherein the target number of queues is used for performing bidirectional communication between the master node and the multiple worker nodes.

In the embodiments of the present disclosure, since the host process runs in a non-trusted environment, the queues are created by the host process, which can improve the efficiency of queue creation. In addition, the master node and the worker nodes are communicated through the queues, which can improve the communication efficiency.

In a possible implementation, each two queues of the target number of queues are paired, and each pair of queues is used for performing bidirectional communication between the master node and one of the worker nodes; and, after creating a target number of queues based on the number of the worker nodes by the host process, the method further comprises:
by the host process, storing the target number of queues in the shared memory, and generating a queue storage address of each queue; and
by the host process, transmitting the queue storage address of each queue in the target number of queues to the master node, and transmitting the queue storage addresses of each pair of queues to a corresponding worker node; wherein the master node and each of the worker nodes communicate based on corresponding queue storage addresses.

In the embodiments of the present disclosure, by placing the queues in the shared contents, the original ecall overhead and copying overhead of encrypted data can be omitted, so that the training efficiency of the model can be further improved.

In a possible implementation, each pair of queues comprises a first queue and a second queue, and the communication process of the master node with any one of the worker nodes comprises the following steps:
controlling the master node to, after encrypting first target data, write the encrypted first target data into the queue storage address of the first queue; and controlling the worker node to acquire the encrypted first target data in accordance with the queue storage address of the first queue; and/or
controlling the worker node to, after encrypting second target data, write the encrypted second target data into the queue storage address of the second queue, and controlling the master node to acquire the encrypted second target data in accordance with the queue storage address of the second queue.

In the embodiments of the present disclosure, for the communication between the master node and any one of the worker nodes, not only the security of data is ensured, but also the efficiency of data transmission is improved, through the encryption technology and the shared memory.

In a possible implementation, the method further comprises:
by the host process, creating a thread pool for the master node and each of the worker nodes, respectively, wherein each thread pool comprises a preset number of threads;
wherein the controlling the master node and each of the worker nodes to train a preset model by using corresponding respective decrypted sub-training data, respectively, to obtain a trained model comprises:
controlling the master node and each of the worker nodes to train the preset model based on the threads within a corresponding respective thread pool, respectively, to obtain the trained model.

In the embodiments of the present disclosure, since the host process runs in a non-trusted environment, thread pools for the training nodes are created respectively by the host process, which can improve the efficiency of thread creation. In addition, the efficiency of training can be further improved by parallel running of multiple threads.

In a possible implementation, the process of encrypting each piece of the sub-training data by the host process shares one symmetric key with the process of decrypting the encrypted sub-training data by each of the training nodes.

In a possible implementation, wherein the master node and at least a portion of the worker nodes are distributed on different physical machines; and the creating a target number of queues based on the number of the worker nodes by the host process, wherein the target number is twice the number of the worker nodes, comprises:
with respect to a target physical machine on which the master node is distributed, creating a target number of queues based on the number of the worker nodes on the target physical machine by the host process which is on the target physical machine, wherein the target number is twice the number of the worker nodes on the target physical machine; wherein the target number of queues is used for performing bidirectional communication between the master node on the target physical machine and multiple worker nodes on the target physical machine. In this way, the expansion of multiple physical machines can be realized, and the security and efficiency of data transmission on the target physical machine can be guaranteed.

In a possible implementation, with respect to another physical machine on which the master node is not distributed, the worker nodes distributed on the another physical machine perform bidirectional communication with the master node on the target physical machine by adopting a Transmission Control Protocol (TCP). In this way, communication among worker nodes and master node distributed on different physical machines can be achieved.

Embodiments of the present disclosure provide a model training apparatus, which comprises:
a data acquisition module configured to, by a host process, acquire training data, and divide the training data for a training node cluster employing a master-workers architecture to obtain multiple pieces of sub-training data; wherein the training node cluster comprises a master node and multiple worker nodes, which are used for performing model training in a collaborative manner; wherein the host process runs in a non-trusted execution environment, and the training node cluster runs in a trusted execution environment;
a data encryption module configured to, by the host process, encrypt each piece of sub-training data, and store the encrypted sub-training data in a shared memory of the host process; wherein the shared memory of the host process is used for being shared by the host process and the training node cluster;
a data transmission module configured to, by the host process, record a data storage address of each piece of the encrypted sub-training data in the shared memory, and transmit respective data storage addresses to corresponding master node and worker nodes, respectively; wherein each data storage address corresponds to one training node;
a data decryption module configured to control the master node and each of the worker nodes to acquire corresponding encrypted sub-training data from the shared memory in accordance with corresponding data storage addresses, respectively, and to decrypt the encrypted sub-training data to obtain decrypted sub-training data;
a model training module configured to control the master node and each of the worker nodes to train a preset model by using corresponding respective decrypted sub-training data, respectively, to obtain a trained model; wherein during the training process, the master node is used for transmitting a training task to each of the worker nodes and for gathering sub-training results transmitted by the worker nodes.

In a possible implementation, the apparatus further comprises an object creation module configured to, by the host process, activate the master node and each of the worker nodes, and control the master node and each of the worker nodes to generate, in accordance with a size of data volume of corresponding sub-training data, a trusted memory matched with the data volume, wherein the trusted memory is used for storing the sub-training data.

In a possible implementation, the preset model is configured on the master node and each of the worker nodes, respectively; wherein the model training module is specifically configured to:
control the master node to assign a corresponding training task to each of the worker nodes based on the decrypted sub-training data corresponding to each of the worker nodes, and control the master node to transmit each training task to a corresponding worker node;
control each of the worker nodes to train the preset model in accordance with a corresponding training task and corresponding decrypted sub-training data to obtain a corresponding sub-training result;
control each of the worker nodes to transmit the corresponding sub-training result to the master node;
control the master node to gather the sub-training result of the master node and the sub-training results of the worker nodes to obtain a total training result;
repeat the above steps until the total training result meets a preset condition.

In a possible implementation, the object creation module is further configured to, by the host process, create a target number of queues based on the number of the worker nodes, wherein the target number is twice the number of the worker nodes; wherein the target number of queues is used for performing bidirectional communication between the master node and the multiple worker nodes.

In a possible implementation, each two queues of the target number of queues are paired, and each pair of queues is used for performing bidirectional communication between the master node and one of the worker nodes; the data transmission module is further configured to:
by the host process, store the target number of queues in the shared memory, and generate a queue storage address of each queue; and
by the host process, transmit the queue storage address of each queue in the target number of queues to the master node, and transmit the queue storage addresses of each pair of queues to a corresponding worker node; wherein the master node and each of the worker nodes communicate based on corresponding queue storage addresses.

In a possible implementation, each pair of queues comprises
a first queue and a second queue; the data encryption module is further configured to:
control the master node to, after encrypting first target data, write the encrypted first target data into the queue storage address of the first queue; and control the worker node to acquire the encrypted first target data in accordance with the queue storage address of the first queue; and/or
control the worker node to, after encrypting second target data, write the encrypted second target data into the queue storage address of the second queue, and control the master node to acquire the encrypted second target data in accordance with the queue storage address of the second queue.

In a possible implementation, the object creation module is further configured to, by the host process, create a thread pool for the master node and each of the worker nodes, respectively, wherein each thread pool comprises a preset number of threads;
the model training module is specifically configured to control the master node and each of the worker nodes to train the preset model based on the threads within a corresponding respective thread pool, respectively, to obtain the trained model.

In a possible implementation, the process of encrypting each piece of the sub-training data by the host process shares one symmetric key with the process of decrypting the encrypted sub-training data by each of the training nodes.

In a possible implementation, the master node and at least a portion of the worker nodes are distributed on different physical machines; the object creation module is specifically configured to:
with respect to a target physical machine on which the master node is distributed, create a target number of queues based on the number of the worker nodes on the target physical machine by the host process which is on the target physical machine, wherein the target number is twice the number of the worker nodes on the target physical machine; wherein the target number of queues is used for performing bidirectional communication between the master node on the target physical machine and multiple worker nodes on the target physical machine.

Embodiments of the present disclosure provide an electronic device, which comprises a processor, a memory and a bus, wherein the memory stores machine-readable instructions executable by the processor, the processor and the memory communicate via the bus when the electronic device runs, and the machine-readable instructions, when executed by the processor, perform the model training method according to any one of the above implementations.

Embodiments of the present disclosure provide a non-transitory computer-readable storage medium, wherein the computer-readable storage medium stores thereon a computer program which, when executed by a processor, causes the processor to implement the model training method according to any one of the above implementations.

In order to make the above-mentioned objectives, features and advantages of the present disclosure more apparent and easier to understand, preferred embodiments with reference to the accompanying drawings are described in detail as follows.

### BRIEF DESCRIPTION OF THE DRAWINGS

In order to illustrate the technical solutions of the embodiments of the present disclosure in a more clearly manner, the accompanying drawings necessary to be used in the embodiments will be briefly described below. The accompanying drawings herein are incorporated in and form a part of the description; they illustrate embodiments consistent with the present disclosure and, together with the description, serve to illustrate the technical solutions of the present disclosure. It is to be understood that the following drawings only depict some embodiments of the present disclosure and are therefore not to be construed as limiting the scope, and for those skilled in the art, other relevant drawings may be derived from these drawings without any creative effort.

FIG. 1 is a schematic diagram illustrating an implementing process of a model training method provided by some embodiments of the present disclosure;

FIG. 2 is a flowchart of a model training method provided by some embodiments of the present disclosure;

FIG. 3 is a schematic diagram illustrating an implementing process of another model training method provided by some embodiments of the present disclosure;

FIG. 4 is a schematic diagram illustrating an implementing process of yet another model training method provided by some embodiments of the present disclosure;

FIG. 5 is a schematic diagram illustrating a communication process between a master node and worker nodes provided by some embodiments of the present disclosure;

FIG. 6 is a schematic diagram of distribution of training nodes on multiple physical machines provided by some embodiments of the present disclosure;

FIG. 7 is a schematic structural diagram of a model training apparatus provided by some embodiments of the present disclosure;

FIG. 8 is a schematic structural diagram of another model training apparatus provided by some embodiments of the present disclosure; and

FIG. 9 is a schematic diagram of an electronic device provided by some embodiments of the present disclosure.

### DETAILED DESCRIPTION

To make the objectives, technical solutions and advantages of the embodiments of the present disclosure more clearly comprehensible, the technical solutions in the embodiments of the present disclosure will be described clearly and completely with reference to the accompanying drawings in the embodiments of the present disclosure, and it is apparent that the described embodiments are only a part of the embodiments of the present disclosure, rather than all of the embodiments. The components of the embodiments of the present disclosure, as described and illustrated in the accompanying drawings herein, can generally be arranged and designed in a variety of different configurations. Thus, the following detailed description of the embodiments of the present disclosure, as provided in the accompanying drawings, is not intended to limit the scope of protection of the present disclosure, yet merely representative of selected embodiments of the present disclosure. All other embodiments, which can be derived by those skilled in the art based on the embodiments of the present disclosure without making any creative effort, shall fall within the scope of protection of the present disclosure.

It should be noted that similar reference signs and letters refer to similar items in the subsequent drawings, and thus, once an item is defined in one drawing, it is not necessary to further define and explain it in the subsequent drawings.

The term “and/or” herein merely describes an associative relationship, meaning that three relationships may exist, e.g., A and/or B may mean three cases, namely A exists alone, A and B exist simultaneously, and B exists alone. In addition, the term “at least one (item)” herein means any one (item) or any combination of at least two of multiple (items), for example, including at least one of A, B and C may mean including any one or more elements selected from the group consisting of A, B and C.

In actual AI applications, in order to ensure security (such as model security, privacy security, etc.), training data needs to be encrypted and then transmitted to a Trusted Execution Environment (TEE), and training of a model is completed in the TEE. However, in the current training method, due to the large quantity of training data, a large trusted memory space needs to be occupied, which results in a reduced efficiency in the activation and operation of the TEE. In addition, the process of transmitting the encrypted training data into the TEE is also complicated, thereby further affecting the efficiency of model training.

Embodiments of the present disclosure at least provide a model training method and apparatus, an electronic device and a storage medium, which can reduce data transmission overhead and improve the activation efficiency on the premise of ensuring privacy of training data, thereby improving the training efficiency of a model.

Isolated by hardware, trusted execution environment can guarantee that sensitive data is stored, processed, and protected in an isolated, trusted environment, and is widely applied to various security applications such as payment, fingerprinting, and Digital Rights Management (DRM). With the development of computer technology, AI technology has been applied to various scenarios such as computer vision, automatic driving, and the like. In actual AI applications, in order to ensure security (such as model security, privacy security, etc.), training data needs to be encrypted and then transmitted to a trusted execution environment, and training of a model is completed in the trusted execution environment.

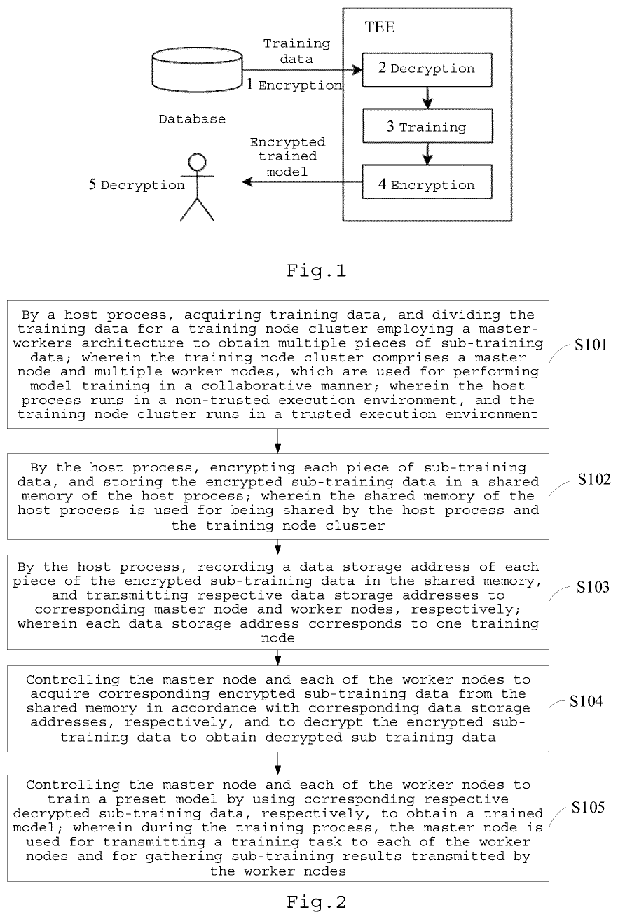

Specifically, as shown in FIG. 1, in the process of training a model, training data is first acquired from the database, then the training data, after being encrypted, is transmitted to the TEE, in which the encrypted training data is first decrypted, then the model is trained based on the decrypted training data to obtain a trained model, and finally the trained model, after being encrypted, is transmitted to a user terminal, and after acquisition of the encrypted trained model, the user terminal decrypts it to obtain the trained model.

It is found through studies that although the above model training method can ensure the privacy of training data and the security of model training, yet due to the large quantity of training data, a large trusted memory space needs to be occupied, which results in a reduced efficiency in the activation and operation of the TEE. In addition, the process of transmitting the encrypted training data into the TEE is also complicated, thereby further affecting the efficiency of model training.

Based on the above studies, the present disclosure provides a model training method, which comprises, by a host process, acquiring training data, and dividing the training data for a training node cluster employing a master-workers architecture to obtain multiple pieces of sub-training data; wherein the training node cluster comprises a master node and multiple worker nodes, which are used for performing model training in a collaborative manner; wherein the host process runs in a non-trusted execution environment, and the training node cluster runs in a trusted execution environment; then, by the host process, encrypting each piece of sub-training data, and storing the encrypted sub-training data in a shared memory of the host process; wherein the shared memory of the host process is used for being shared by the host process and the training node cluster; next, by the host process, recording a data storage address of each piece of the encrypted sub-training data in the shared memory, and transmitting respective data storage addresses to corresponding master node and worker nodes, respectively; wherein each data storage address corresponds to one training node; next, controlling the master node and each of the worker nodes to acquire corresponding encrypted sub-training data from the shared memory in accordance with corresponding data storage addresses, respectively, and to decrypt the encrypted sub-training data to obtain decrypted sub-training data; and finally, controlling the master node and each of the worker nodes to train a preset model by using corresponding respective decrypted sub-training data, respectively, to obtain a trained model; wherein during the training process, the master node is used for transmitting a training task to each of the worker nodes and for gathering sub-training results transmitted by the worker nodes.

In the model training method provided by the embodiments of the present disclosure, by training the model in a collaborative manner by the training node cluster employing a distributed master-workers architecture, the originally large training data can be divided into multiple pieces of small training data, so that the activation and operation efficiency of each training node can be improved. In addition, by storing the encrypted training data into the shared memory area by the host process, different training nodes can read and write the shared memory area. That is, each training node can directly perform decryption operation on the shared memory, and place a decryption result in the training node, so that original ecall overhead and copying overhead of encrypted data can be omitted and the training efficiency of the model can be further improved.

To facilitate understanding of the present embodiment, a detailed description will be given to an execution subject of the model training method provided by the embodiment of the present disclosure. Specifically, the execution subject of the model training method provided by the embodiment of the present disclosure is an electronic device configured with a TEE. In this embodiment, the electronic device is a server, which may be an independent physical server, a server cluster or a distributed system composed of a plurality of physical servers, or a cloud server providing basic cloud computing services such as cloud service, cloud database, cloud computing, cloud storage, Big Data, and an artificial intelligence platform. In other embodiments, the electronic device may further be a terminal device, and the terminal device may further be a mobile device, a user terminal, a terminal, a hand-held device, a computing device, a vehicle-mounted device, a wearable device, etc. Optionally, the model training method may also be implemented in such a way that a processor calls computer-readable instructions stored in the memory.

A detailed description will be given below to the model training method provided by the embodiment of the present disclosure with reference to the accompanying drawings. Referring to FIG. 2, which is a flowchart of a model training method provided by the embodiment of the present application, the model training method comprises the following steps S101 to S105:
S101, by a host process, acquiring training data, and dividing the training data for a training node cluster employing a master-workers architecture to obtain multiple pieces of sub-training data; wherein the training node cluster comprises a master node and multiple worker nodes, which are used for performing model training in a collaborative manner; wherein the host process runs in a non-trusted execution environment, and the training node cluster runs in a trusted execution environment.

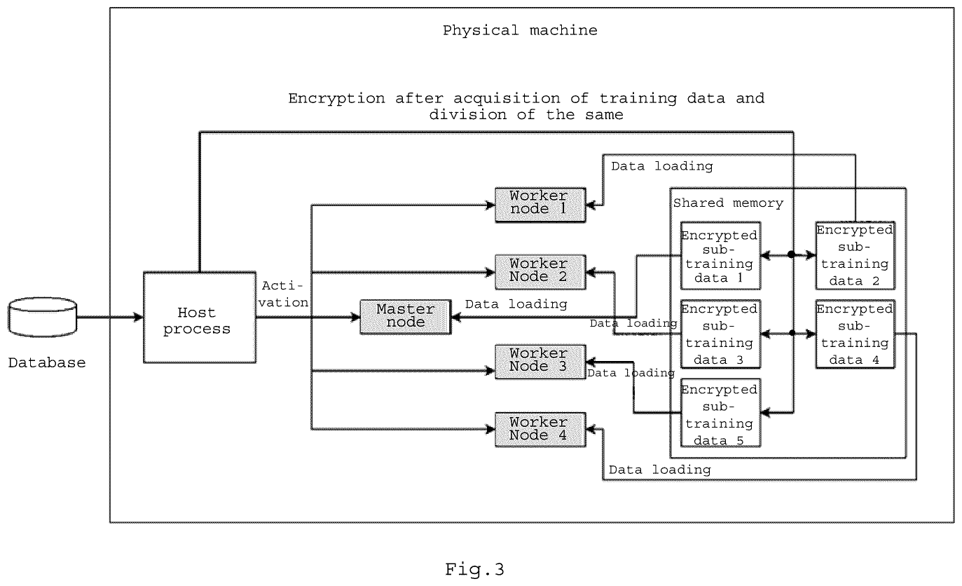

Referring to FIG. 3, in some embodiments, the model training method is applied to a physical machine, which is an electronic device, such as the aforementioned server. The physical machine is configured with a TEE and a non-TEE, the TEE and non-TEE running in parallel and the TEE being more secure relative to the non-TEE.

Specifically, the TEE may be a secure area separated from a Central Processing Unit (CPU), or may be a TEE chip independent of the CPU, wherein the TEE offers secure services to the outside and can ensure that code and data loaded therein are protected in terms of confidentiality and integrity. Trusted applications running in the TEE have access to the full functionality of the main processor and memory of the device, while hardware isolation protects these trusted applications from being affected by user-installed applications running in the main operating system. The non-TEE may be a Rich Execution Environment (REE) or may be a normal Execution Environment.

Exemplarily, a training node cluster of a master-workers architecture may be employed to train the model, the training node cluster including a master node and multiple worker nodes, wherein the worker nodes may be worker nodes 1 to 4 as shown in FIG. 3, and the master node and the multiple worker nodes are used for performing model training in a collaborative manner. In the embodiments of the present disclosure, the master node and the worker node are both referred to as training nodes.

It should be understood that both the host process and the training nodes are program processes on a physical machine, with differences in that the host process runs in a non-trusted execution environment and the training node cluster runs in a trusted execution environment.

The training data refers to sample data required for model training, which sample data comprises sample images. It can be understood that the field of training data varies depending on the field of application of the trained model. For example, if the trained model is applied to the field of automatic driving, the training data includes sample images of the vehicle driving environment; and if the trained model is applied to the field of article sorting, the training data includes sample images of various articles. Training data needs to be collected before model training, and the training data is stored in a database, so as to facilitate subsequent training of the model by multiple training nodes.

Specifically, after the training data is acquired from the database by the host process, in order to facilitate training of the preset model by each training node, the host process may divide the training data with respect to a training node cluster employing a master-workers architecture to obtain multiple pieces of sub-training data. Specifically, the training data may be divided in accordance with the number of training nodes that need to be activated, wherein the number of training nodes that need to be activated may be determined by resources possessed by the user. In some embodiments, in order to enable multiple training nodes to obtain training results synchronously to improve the training efficiency, training data may be divided equally based on the number of training nodes that need to be activated; taking five training nodes as an example for illustration, training data M may be divided into five equal parts to obtain five pieces of sub-training data, which are M/5 respectively. Certainly, in other embodiments, the training data may not be divided equally, and this may be determined specifically in accordance with actual demands, to which no definition is made herein.

In some possible implementations, after obtaining multiple pieces of sub-training data corresponding to the number of training nodes, the method further comprises: by the host process, activating the master node and the worker nodes, and controlling the master node and the worker nodes to generate, in accordance with a size of data volume of corresponding sub-training data, a trusted memory matched with the data volume, wherein the trusted memory is used for storing the sub-training data. That is, after the division of data, the corresponding trusted memory space can be adaptively generated in accordance with the data volume of the sub-training data. The trusted memory space is used for storing intermediate variables of the operation program of the training node, in addition to storing the sub-training data.

Exemplarily, the trusted memory space of each training node may be twice as large as the data volume of the corresponding sub-training data, and certainly, may also be more (e.g., three times) or less (e.g., 1.8 times), to which no specific definition is made herein. It can be understood that, in the TEE, each training node corresponds to an independent enclave, that is, the training node runs on the corresponding enclave, and the size of the trusted memory of the training node is namely the size of the trusted memory of the corresponding enclave.

S102, by the host process, encrypting each piece of sub-training data and storing the encrypted sub-training data in a shared memory of the host process; wherein the shared memory of the host process is used for being shared by the host process and the training node cluster.

Exemplarily, after multiple pieces of sub-training data corresponding to the number of training nodes are obtained, each piece of sub-training data may be encrypted by the host process, and the encrypted sub-training data is stored in a shared memory of the host, so as to facilitate acquisition of the sub-training data from the shared memory by the master node and the worker nodes. As shown in FIG. 3, the encrypted sub-training data 1, the encrypted sub-training data 2, the encrypted sub-training data 3, the encrypted sub-training data 4 and the encrypted sub-training data 5 are all stored in the shared memory.

S103, by the host process, recording a data storage address of each piece of encrypted sub-training data in the shared memory, and transmitting respective data storage addresses to corresponding master node and worker nodes, respectively; wherein each data storage address corresponds to one training node.

Specifically, after the encrypted sub-training data is stored in the shared memory of the host, the data storage address of each piece of the encrypted sub-training data in the shared memory may be recorded by the host process; for example, the data storage addresses corresponding to the five pieces of encrypted sub-training data are dp1 to dp5 respectively, and then respective data storage address are transmitted to the corresponding training nodes. For example, the data storage address dp1 is transmitted to the master node, the data storage address dp2 is transmitted to the work node 1, the data storage address dp3 is transmitted to the work node 2, the data storage address dp4 is transmitted to the work node 3, and the data storage address dp5 is transmitted to the work node 4, that is, each data storage address corresponds to one training node.

S104, controlling the master node and each of the worker nodes to acquire corresponding encrypted sub-training data from the shared memory in accordance with the corresponding data storage addresses, respectively, and decrypting the encrypted sub-training data to obtain decrypted sub-training data.

After respective data storage addresses are transmitted to the corresponding training nodes, the master node and each of the worker nodes may be controlled to acquire corresponding encrypted sub-training data from the shared memory respectively in accordance with the corresponding data storage address and to decrypt the encrypted sub-training data to obtain decrypted sub-training data. Specifically, the master node may acquire the encrypted sub-training data 1 in accordance with the data storage address dp1 and decrypt the encrypted sub-training data 1 to obtain the decrypted sub-training data 1 (that is, the original sub-training data 1), and the process of acquiring data by each of the worker nodes is similar to that of the master node and is not described herein any more.

It should be noted that, in order to improve the efficiency of the encryption and decryption processes, one symmetric key is used in the process of encrypting each piece of sub-training data by the host process and the process of decrypting the encrypted sub-training data by each training node, that is, the host process and each node share one symmetric key. Herein, the symmetric key may be preset, or may be a key obtained through Remote Authentication (RA), or a key obtained through other key agreement manners, to which no definition is made herein.

S105, controlling the master node and each of the worker nodes to train a preset model by using the corresponding respective decrypted sub-training data, respectively, to obtain a trained model; wherein during the training process, the master node is used for transmitting a training task to each of the worker nodes and for gathering sub-training results transmitted by the worker nodes.

It can be understood that, since the same preset model is stored in both the master node and each of the worker nodes, after the master node and each of the worker nodes respectively acquire the corresponding decrypted sub-training data, the master node and the worker nodes can be controlled to train the preset model by using corresponding respective decrypted sub-training data, respectively, so as to obtain a trained model. In the training process, the master node is used for transmitting a training task to each of the worker nodes and to gather sub-training results transmitted by the worker nodes. That is, the master node participates in the training synchronously under the premise of being in charge of the entire training logic, and aggregates the model parameters obtained from the worker nodes.

The specific type of the preset model is not defined herein, which may be a Convolutional Neural Network (CNN), a Generative Adaptive Network (GAN), a linear regression, a k-mean (clustering), and the like. In addition, in accordance with different application scenarios, the functions achieved by the preset model are also different; for example, the preset model may be a model for implementing target detection, or may be a model for implementing article sorting, to which no specific definition is made herein.

In the model training method provided by the embodiments of the present disclosure, since the model is trained in a collaborative manner by the training node cluster employing the master-workers architecture, the originally large training data can be divided into multiple pieces of small training data, so that the activation and operation efficiency of each training node can be improved. Further, since the host process and the training node cluster share the shared memory of the host process, the encrypted training data is stored in the shared memory area by the host process, and different training nodes can read and write the shared memory area. That is, each training node can directly perform decryption operation on the shared memory, and place a decryption result into the training node, so that original ecall overhead and copying overhead of encrypted data can be omitted and the training efficiency of the model can be further improved.

It should be noted that, if there were no shared memory, the host process would deliver the encrypted sub-training data to the enclave in an ecall manner, the encrypted sub-training data would be copied into the enclave, and the enclave thread would decrypt the encrypted sub-training data; the overhead in this process would lie in that the encrypted sub-training data was subject to a copying and there would be an ecall in the host process for data transmission; Therefore, with the shared memory technology, ecall overhead and copying overhead for the encrypted data may be omitted, and accordingly the model training efficiency may be further improved.

Herein, the ecall method is the only channel for accessing the interior of enclave from the exterior of the enclave, but the execution process thereof is protected by a trusted environment. All methods not declared as ecall cannot perform a call from outside of enclave, and ocall is a type of method that calls the exterior of enclave from the interior of enclave.

Referring again to FIG. 3, in some embodiments, when controlling the master node and each of the worker nodes to train a preset model by using corresponding respective decrypted sub-training data, respectively, step S105 may comprises the following steps (1) to (5):
(1) controlling the master node to assign a corresponding training task to each of the worker nodes based on the decrypted sub-training data corresponding to each of the worker nodes, and controlling the master node to transmit each training task to a corresponding worker node;
(2) controlling each of the worker nodes to train the preset model in accordance with a corresponding training task and corresponding decrypted sub-training data to obtain a corresponding sub-training result;
(3) controlling each of the worker nodes to transmit the corresponding sub-training result to the master node;
(4) controlling the master node to gather the sub-training result of the master node and the sub-training results of the worker nodes to obtain a total training result;
(5) repeating the above steps until the total training result meets a preset condition.

In the above training process, the master node is responsible for the entire logic of model training, will assign a corresponding training task to each of the worker nodes based on the decrypted sub-training data corresponding to each of the worker nodes, and transmit each training task to a corresponding worker node, and will synchronously train the preset model together with each of the worker nodes.

In each round of the training process, the master node acquires sub-training result (also referred to as model parameters) of each of the worker nodes, and then aggregates the sub-training results of the master node and the worker nodes to obtain a total training result (total model parameters) of the preset model; subsequently, the master node re-transmits the model parameters corresponding to each worker node to the corresponding worker node in accordance with the sub-training data corresponding to each worker node, and each of the worker nodes performs another round of training on the preset model in accordance with the corresponding sub-training data and the current model parameters, such a process is repeated until the total training result meets the preset condition.

Herein, the total training result meeting the preset condition means that the training times reach the preset times, or the loss function of the model is smaller than a preset threshold value, namely, the model converges to a preset degree.

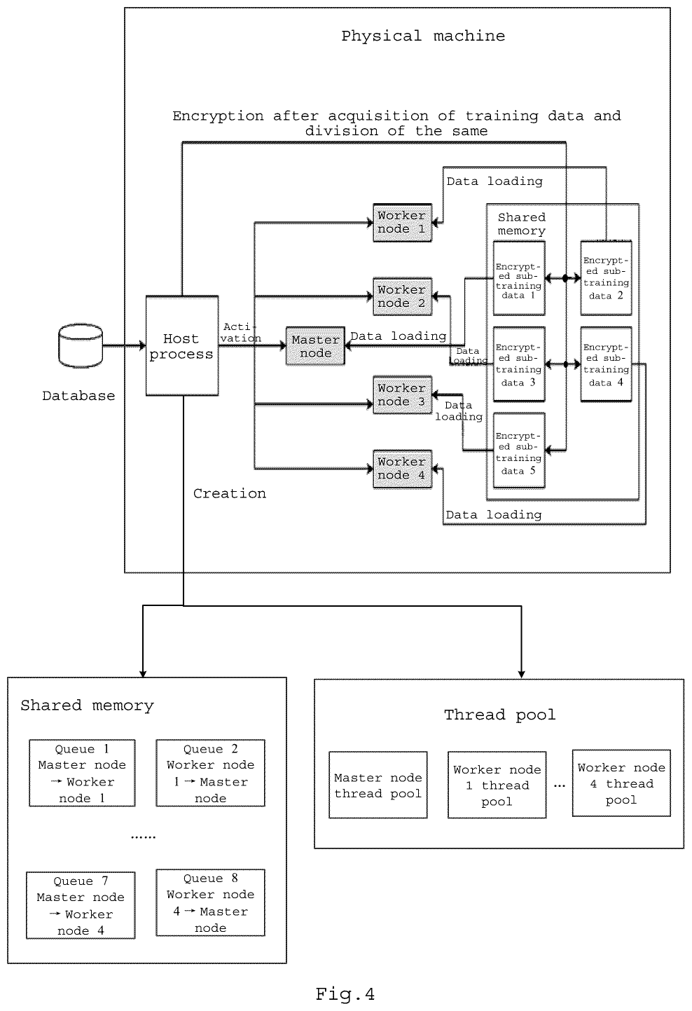

Referring to FIG. 4, in some embodiments, in order to improve the communication efficiency, the method further comprises: by the host process, creating a target number of queues based on the number of the worker nodes, wherein the target number is twice the number of the worker nodes. Herein, the target number of queues is used for performing bidirectional communication between the master node and the multiple worker nodes. For example, if there are five training nodes, among which there is one master node and four worker nodes, then eight queues need to be created for bidirectional communication between one master node and four worker nodes.

Exemplarily, in the model training process, the master node and the worker nodes may transmit information through the created queues. Specifically, the master node may be controlled to transmit each training task to the corresponding work node through the queues, and each work node may be controlled to transmit the corresponding sub-training result to the master node through the queues.

Optionally, each two queues of the target number of queues are paired, and each pair of queues is used for performing bidirectional communication between the master node and one of the worker nodes; and, after creating a target number of queues based on the number of the worker nodes by the host process, the method further comprises the following steps:
by the host process, storing the target number of queues in the shared memory, and generating a queue storage address of each queue;
by the host process, transmitting the queue storage address of each queue in the target number of queues to the master node, and transmitting the queue storage addresses of each pair of queues to a corresponding worker node; wherein the master node and each of the worker nodes communicate based on corresponding queue storage addresses.

Taking four worker nodes as an example for illustration, specifically, after eight queues are placed in the shared memory by the host process, queue storage addresses qp₁ to qp₈ of the eight queues can be generated; then, the queue storage addresses qp₁ to gp₈ of the eight queues are transmitted to the master node by the host process, and the queue storage addresses qp₂ᵢ₋₁ and qp₂ᵢ are transmitted to the worker node i, and for example, if the worker node i is a worker node 1, the queue storage address qp₁ (the address of queue 1 in FIG. 4) and the queue storage address qp₂ (the address of queue 2 in FIG. 4) are transmitted to the worker node 1.

Further optionally, each pair of queues comprises a first queue and a second queue, and the communication process of the master node with any one of the worker nodes comprises the following steps:
controlling the master node to, after encrypting first target data, write the encrypted first target data into the queue storage address of the first queue; and controlling the worker node to acquire the encrypted first target data in accordance with the queue storage address of the first queue; and/or
controlling the worker node to, after encrypting second target data, write the encrypted second target data into the queue storage address of the second queue, and controlling the master node to acquire the encrypted second target data in accordance with the queue storage address of the second queue.

It can be understood that the data transmission between the master node and the worker node needs to adopt the encryption technology and the shared memory to ensure security and efficiency, for example, the master node is to transmit data A to the worker node 1, here the master node needs to first encrypt A with a key k and then to write corresponding encrypted data into an address qp₁, and the worker node 1 can directly read the address qp₁ to obtain the encrypted data, thereby realizing the process of transmitting data to the worker node by the master node.

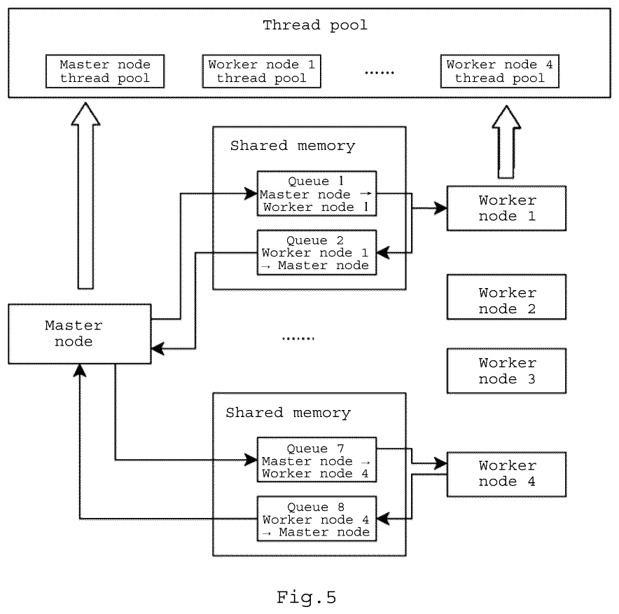

Referring to FIG. 5, a description is made with the above model training process as an example. In each round of the training process, the master node may be controlled to write the encrypted training task into the queue storage address of the corresponding first queue (for example, queue 1) after encrypting the training task; and then a corresponding worker node (for example, the worker node 1) is controlled to acquire the encrypted training task in accordance with the queue storage address of the first queue, in which way the communication process of controlling the master node to transmit the training task to the corresponding worker node is realized. In addition, the worker node (worker node 1) may further be controlled to write the encrypted sub-training result into the queue storage address of the corresponding second queue (queue 2) after encrypting the corresponding sub-training result; and then the master node is controlled to acquire the encrypted sub-training result in accordance with the queue storage address of the second queue, thereby realizing the communication process of controlling the worker node to transmit the sub-training result to the master node.

Referring again to FIG. 4, in some embodiments, the method further comprises: by the host process, creating a thread pool for the master node and each of the worker nodes, respectively, wherein each thread pool comprises a preset number of threads. Herein, the preset number of threads in each thread pool is determined by the size of amount of the resources that the user possesses. It can be understood that the resources possessed by the user may be resources previously allocated to the user, for example, the resources may be obtained by purchase.

As shown in FIG. 5, since a thread pool is created for each training node in advance by a host process, the controlling the master node and each of the worker nodes to train a preset model by using corresponding respective decrypted sub-training data, respectively, to obtain a trained model may comprises: controlling the master node and each of the worker nodes to train the preset model based on the threads within a corresponding respective thread pool, respectively, to obtain the trained model, which can accordingly further improve the model training efficiency. Specifically, for any one thread in each thread pool, when the thread has no computing task, it can poll the task queue, and perform computation when a new task is found; when the task is completed, it polls the queue again.

It can be understood that, in the case where no thread pool is used, when an enclave main thread (assuming that the thread ID is 1) needs an additional thread to help execute the computing task, the following process needs to be performed:

An ocall is made to a host process, that is, a conversion from a trusted environment to a non-trusted environment is made once, resulting in high overhead; a pthrea_create function is called, a thread is newly created (assuming that the thread ID is 2), and after the thread 2 is created, a thread 1 is returned to the enclave through an ecall (the ecall overhead is high); the thread 2 also needs to enter the enclave through the ecall to execute computing (the ecall overhead is high); after the thread 2 finishes computing, the ocall is made to exit the enclave and the thread is destroyed (the ocall overhead is high). Therefore, in the case where no thread pool is created in advance by the host process, the conversion from the trusted environment to the non-trusted environment is to be made four times each time a new thread is created for computing, and the overhead is very high. Herein, pthrea_create is a function of thread creation of the Unix-like operating system (Unix, Linux, Mac OS X, etc.). Its function is to create a thread (in fact, to determine the entry point of calling the thread function), and after thread creation, the associated thread function starts running.

However, in the case where a thread pool is created in advance by the host process, all threads enter the thread pool of the enclave through ecall upon activation of the program to wait for computing tasks. When an enclave main thread needs an additional thread to help execute a computing task, it is only necessary to locate an idle thread from the thread pool to help computing, and this process does not involve the conversion between the trusted environment and the non-trusted environment. Therefore, creation of a thread pool for each training node in advance by a host process can save communication overheads and further improve the training efficiency.

It should be understood that the above embodiments are described for the case of one physical machine, that is, the master node and the worker nodes are distributed on one physical machine, however, the model training method may also be extended to multiple physical machines, namely the case where the master node and the worker nodes are distributed on different physical machines.

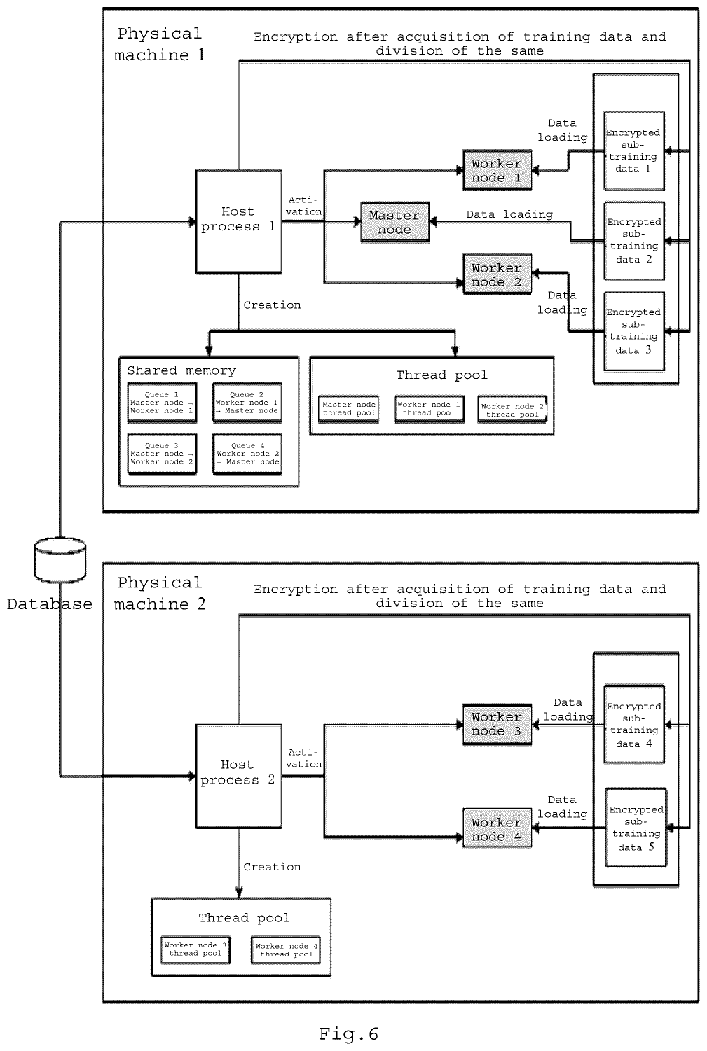

The following description will be made directed to the case where the master node and multiple worker nodes are distributed on two physical machines. Specifically, as shown in FIG. 6, each physical machine is configured with a TEE and a non-TEE, and each physical machine is provided with a host process, so that the host process of each physical machine can be controlled to respectively acquire training data; in this embodiment, the host process on each physical machine acquires the same training data, then one of the host processes is controlled to divide the training data in accordance with the total number of nodes (the number of nodes distributed on all physical machines) and to transmit the division result to the other host processes, for example, if the training data is divided by the host process 1, the division result is transmitted (notified) to the host process 2; then, each host process performs data encryption processing based on the number of training nodes on the physical machine where the host process is located, and the subsequent processes are similar to the methods in the foregoing embodiments and are not described herein again.

It should be noted that, unlike the foregoing embodiments, the master node communicates with the worker nodes distributed on the same physical machine by adopting the aforementioned technology of creating queues and storing the created the queues in the shared memory, while communicating with the worker nodes distributed on a different physical machine by adopting a Transmission Control Protocol (TCP).

Specifically, for the target physical machine 1 with the master node distributed thereon, a target number of queues is created by the host process 1 on the target physical machine 1 based on the number of the worker nodes on the target physical machine 1, wherein the target number is twice the number of the worker nodes on the target physical machine, that is, four queues need to be created, which are used for performing bidirectional communication between the master node on the target physical machine 1 and multiple worker nodes (worker node 1 and worker node 2) on the target physical machine. However, for another physical machine 2 without the master node distributed thereon, the worker nodes (worker node 3 and worker node 4) distributed on the another physical machine 2 adopt TCP to perform bidirectional communication with the master node on the target physical machine 1.

It can be understood by those skilled in the art that in the above method of the specific embodiment, the order in which the steps are listed does not imply a strict order of execution and does not impose any limitation on the implementing process, rather the specific order of execution of the steps should be determined by functions and possible inherent logic thereof.

Based on the same technical concept, a model training apparatus corresponding to the model training method is also provided in the embodiments of the present disclosure, and since the problem-solving principle of the apparatus in the embodiments of the present disclosure is similar to that of the above model training method in the embodiments of the present disclosure, references can be made to the implementation of the method for the implementation of the apparatus, and the repeated parts are no longer described herein.

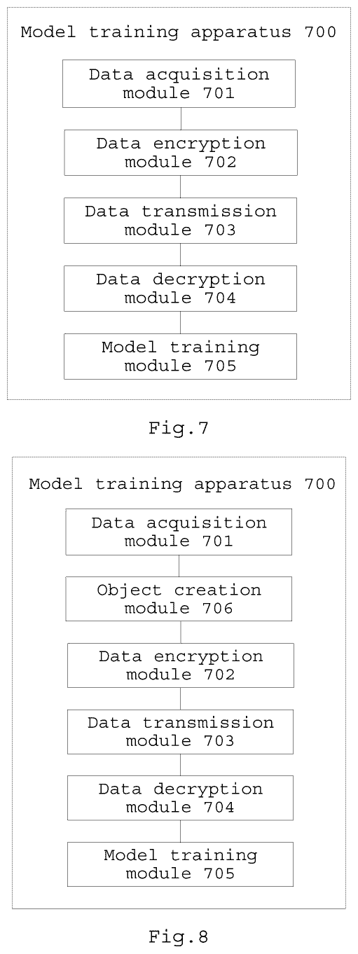

Reference is made to FIG. 7, which is a schematic diagram of a model training apparatus 700 provided by the embodiments of the present disclosure, the apparatus comprises:
a data acquisition module 701 configured to, by a host process, acquire training data, and divide the training data for a training node cluster employing a master-workers architecture to obtain multiple pieces of sub-training data; wherein the training node cluster comprises a master node and multiple worker nodes, which are used for performing model training in a collaborative manner; wherein the host process runs in a non-trusted execution environment, and the training node cluster runs in a trusted execution environment;
a data encryption module 702 configured to, by the host process, encrypt each piece of sub-training data, and store the encrypted sub-training data in a shared memory of the host process; wherein the shared memory of the host process is used for being shared by the host process and the training node cluster;
a data transmission module 703 configured to, by the host process, record a data storage address of each piece of the encrypted sub-training data in the shared memory, and transmit respective data storage addresses to corresponding master node and worker nodes, respectively; wherein each data storage address corresponds to one training node;
a data decryption module 704 configured to control the master node and each of the worker nodes to acquire corresponding encrypted sub-training data from the shared memory in accordance with corresponding data storage addresses, respectively, and to decrypt the encrypted sub-training data to obtain decrypted sub-training data;
a model training module 705 configured to control the master node and each of the worker nodes to train a preset model by using corresponding respective decrypted sub-training data, respectively, to obtain a trained model; wherein during the training process, the master node is used for transmitting a training task to each of the worker nodes and for gathering sub-training results transmitted by the worker nodes.

In a possible implementation, referring to FIG. 8, the apparatus further comprises an object creation module 706, which is configured to
by the host process, activate the master node and each of the worker nodes, and control the master node and each of the worker nodes to generate, in accordance with a size of data volume of corresponding sub-training data, a trusted memory matched with the data volume, wherein the trusted memory is used for storing the sub-training data.

In a possible implementation, the multiple training nodes comprise a master node and multiple worker nodes, and the preset model is stored on the master node and each of the worker nodes, respectively; wherein the model training module 705 is specifically configured to:
control the master node to assign a corresponding training task to each of the worker nodes based on the decrypted sub-training data corresponding to each of the worker nodes, and control the master node to transmit each training task to a corresponding worker node;
control each of the worker nodes to train the preset model in accordance with a corresponding training task and corresponding decrypted sub-training data to obtain a corresponding sub-training result;
control each of the worker nodes to transmit the corresponding sub-training result to the master node;
control the master node to gather the sub-training result of the master node and the sub-training results of the worker nodes to obtain a total training result;
repeat the above steps until the total training result meets a preset condition.

In a possible implementation, the object creation module 706 is further configured to, by the host process, create a target number of queues based on the number of the worker nodes, wherein the target number is twice the number of the worker nodes; wherein the target number of queues is used for performing bidirectional communication between the master node and the multiple worker nodes.

In a possible implementation, each two queues of the target number of queues are paired, and each pair of queues is used for performing bidirectional communication between the master node and one of the worker nodes; the data transmission module 703 is further configured to:
by the host process, store the target number of queues in the shared memory, and generate a queue storage address of each queue; and
by the host process, transmit the queue storage address of each queue in the target number of queues to the master node, and transmit the queue storage addresses of each pair of queues to a corresponding worker node; wherein the master node and each of the worker nodes communicate based on corresponding queue storage addresses.

In a possible implementation, each pair of queues comprises a first queue and a second queue; the data encryption module 702 is further configured to:
control the master node to, after encrypting first target data, write the encrypted first target data into the queue storage address of the first queue; and control the worker node to acquire the encrypted first target data in accordance with the queue storage address of the first queue; and/or
control the worker node to, after encrypting second target data, write the encrypted second target data into the queue storage address of the second queue, and control the master node to acquire the encrypted second target data in accordance with the queue storage address of the second queue.

In a possible implementation, the object creation module 706 is further configured to, by the host process, create a thread pool for the master node and each of the worker nodes, respectively, wherein each thread pool comprises a preset number of threads; the model training module 705 is specifically configured to control the master node and each of the worker nodes to train the preset model based on the threads within a corresponding respective thread pool, respectively, to obtain the trained model.

In a possible implementation, the process of encrypting each piece of the sub-training data by the host process shares one symmetric key with the process of decrypting the encrypted sub-training data by each of the training nodes.

In a possible implementation, the master node and at least a portion of the worker nodes are distributed on different physical machines; and the object creation module 706 is specifically configured to:
with respect to a target physical machine on which the master node is distributed, create a target number of queues based on the number of the worker nodes on the target physical machine by the host process which is on the target physical machine, wherein the target number is twice the number of the worker nodes on the target physical machine; wherein the target number of queues is used for performing bidirectional communication between the master node on the target physical machine and multiple worker nodes on the target physical machine.

In a possible implementation, the data transmission module 703 is further configured to:
with respect to another physical machine on which the master node is not distributed, control the worker nodes distributed on the another physical machine to perform bidirectional communication with the master node on the target physical machine by adopting a Transmission Control Protocol (TCP).

For the description of the processing flow of each module in the apparatus and the interaction flows among the modules, references may be made to the relevant description in the above method embodiments, and will not be described in detail herein.

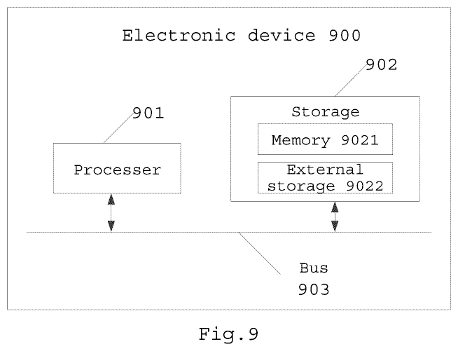

Based on the same technical concept, the embodiments of the present disclosure further provide an electronic device. Referring to FIG. 9, which is a schematic structural diagram of an electronic device 900 provided by the embodiments of the present disclosure, the electronic device comprises a processor 901, a storage 902 and a bus 903. Herein, the storage 902 serves to store execution instructions and includes a memory 9021 and an external storage 9022; the memory 9021 here is also referred to as an internal storage, which serves to temporarily store computing data in the processor 901 and data exchanged with the external storage 9022 such as a hard disk, and the processor 901 exchanges data with the external storage 9022 via the memory 9021.

In the embodiments of the present application, the storage specifically serves to store application program code for executing the technical solutions of the present application, and the processor 901 controls the execution. That is, when the electronic device 900 is running, the processor 901 communicates with the storage 902 via the bus 903, so that the processor 901 executes the application program code stored in the storage 902, thereby implementing the method described in any one of the previous embodiments.

Herein, the storage 902 may be, but is not limited to, a Random Access Memory (RAM), a Read Only Memory (ROM), a Programmable Read-Only Memory (PROM), an Erasable Programmable Read-Only Memory (EPROM), an Electric Erasable Programmable Read-Only Memory (EEPROM), and the like.

The processor 901 may be an integrated circuit chip having signal processing capabilities. The above processor may be a general processor, including a Central Processing Unit (CPU), a Network Processor (NP), and the like; and it may also be a Digital Signal Processor (DSP), an Application Specific Integrated Circuit (ASIC), a Field Programmable Gate Array (FPGA) or other programmable logic apparatus, discrete gate or transistor logic, and discrete hardware components. The various methods, steps, and logic blocks disclosed in the embodiments of the present disclosure may be implemented or performed. A general processor may be a microprocessor or the processor may be any conventional processor or the like.

It can be understood that the illustrated architectures of the embodiments of the present application do not constitute specific definitions to the electronic device 900. In some other embodiments of the present application, the electronic device 900 may include more or fewer components than illustrated, or some components may be combined, some components may be split, or different arrangements of components may apply. The illustrated components may be implemented in hardware, software, or a combination of software and hardware.

Embodiments of the present disclosure further provide a non-transitory computer-readable storage medium, wherein the computer-readable storage medium stores thereon a computer program which, when executed by a processor, causes the processor to implement the steps of the model training method in the above method embodiments. Herein, the storage medium may be a volatile or non-volatile computer-readable storage medium.

Embodiments of the present disclosure further provide a computer program product, wherein the computer program product carries program code, and instructions included in the program code may be used for executing the steps of the model training method in the above method embodiments. References can be made to the above method embodiments, and no further description is made herein.

Herein, the above computer program product may be implemented by hardware, software or a combination thereof. In an optional embodiment, the computer program product is embodied as a computer storage medium, and in another optional embodiment, the computer program product is embodied as a software product, such as Software Development Kit (SDK) or the like.

It can be clearly understood by those skilled in the art that, in view of convenience and simplicity of description, for the specific working process of the system and the apparatus as described above, references may be made to the corresponding process in the foregoing method embodiments, and no more details are described herein. In the several embodiments provided in the present disclosure, it should be understood that the disclosed system, apparatus and method may be implemented in other ways. The above-described apparatus embodiments are merely illustrative; for example, the division of the units is merely one type of logical function division, and in practical implementation, other division manners may exist; a further example is that multiple units or components may be combined or integrated into another system, or some features may be omitted or not implemented. In addition, the shown or discussed coupling or direct coupling or communication connection between one another may be realized via some communication interfaces, and indirect coupling or communication connection among apparatuses or units and may be in an electrical, mechanical or other form.

The units described as separate components may or may not be physically separate, and components displayed as units may or may not be physical units, that is, they may be located in one position, or may be distributed on multiple network units. Some or all of the units can be selected in accordance with actual needs to achieve the purpose of the solution of the present embodiment.

In addition, functional units in the embodiments of the present disclosure may be integrated into one processing unit, or each unit may exist alone physically, or two or more units may be integrated into one unit.

The functions, if implemented in software functional units and sold or used as a stand-alone product, may be stored in a non-volatile computer-readable storage medium which is executable by a processor. Based on such understanding, the essential part or the part contributing to the related art of the technical solutions of the present disclosure, or parts of the technical solutions, may be embodied in the form of a software product, and the computer software product is stored in a storage medium and comprises several instructions for enabling a computer device (which may be a personal computer, a server, or a network device) to execute all or part of the steps of the method described in the embodiments of the present disclosure. And the aforementioned storage medium includes U disk, removable hard disk, read-only memory, random access memory, magnetic disk or optical disk, and other media that can store program code.

Finally, it should be noted that, the embodiments as described above are merely specific implementations of the present disclosure, which are only intended to be used for illustrating the technical solutions of the present disclosure, rather than for limiting the same, and the scope of protection of the present disclosure is not limited thereto; although the present disclosure has been described in detail with reference to the above-mentioned embodiments, those of ordinary skill in the art shall understand that the technical solutions described in the above-mentioned embodiments may still be modified, or some or all of the technical features may be equivalently replaced within the technical scope as disclosed by the present disclosure by any one of ordinary skill in the art; however, such modifications or replacements will not cause the essence of the corresponding technical solutions to depart from the scope of the technical solutions of the embodiments of the present disclosure, and they should be construed as being included therein. Thus, the scope of protection of the present disclosure shall be determined by the terms of the claims.

What is claimed is:

1. A method for training a model, comprising:
by a host process, acquiring training data, and dividing the training data for a training node cluster employing a master-workers architecture to obtain multiple pieces of sub-training data; wherein the training node cluster comprises a master node and multiple worker nodes, which are used for performing model training in a collaborative manner; wherein the host process runs in a non-trusted execution environment, and the training node cluster runs in a trusted execution environment;
by the host process, encrypting each piece of sub-training data, and storing the encrypted sub-training data in a shared memory of the host process; wherein the shared memory of the host process is used for being shared by the host process and the training node cluster;
by the host process, recording a data storage address of each piece of the encrypted sub-training data in the shared memory, and transmitting respective data storage addresses to corresponding master node and worker nodes, respectively; wherein each data storage address corresponds to one training node;
controlling the master node and each of the worker nodes to acquire corresponding encrypted sub-training data from the shared memory in accordance with corresponding data storage addresses, respectively, and to decrypt the encrypted sub-training data to obtain decrypted sub-training data; and
controlling the master node and each of the worker nodes to train a preset model by using corresponding respective decrypted sub-training data, respectively, to obtain a trained model; wherein during the training process, the master node is used for transmitting a training task to each of the worker nodes and for gathering sub-training results transmitted by the worker nodes.

2. The method according to claim 1, wherein, after obtaining the multiple pieces of sub-training data corresponding to the number of the training nodes, the method further comprises:
by the host process, activating the master node and each of the worker nodes, and controlling the master node and each of the worker nodes to generate, in accordance with a size of data volume of corresponding sub-training data, a trusted memory matched with the data volume, wherein the trusted memory is used for storing the sub-training data.

3. The method according to claim 1, wherein the preset model is configured on the master node and each of the worker nodes, respectively; and the controlling the master node and each of the worker nodes to train a preset model by using corresponding respective decrypted sub-training data, respectively, to obtain a trained model comprises:
controlling the master node to assign a corresponding training task to each of the worker nodes based on the decrypted sub-training data corresponding to each of the worker nodes, and controlling the master node to transmit each training task to a corresponding worker node;
controlling each of the worker nodes to train the preset model in accordance with a corresponding training task and corresponding decrypted sub-training data to obtain a corresponding sub-training result;
controlling each of the worker nodes to transmit the corresponding sub-training result to the master node;
controlling the master node to gather the sub-training result of the master node and the sub-training results of the worker nodes to obtain a total training result; and
repeating the above steps until the total training result meets a preset condition.

4. The method according to claim 1, wherein the method further comprises:
by the host process, creating a target number of queues based on the number of the worker nodes, wherein the target number is twice the number of the worker nodes; wherein the target number of queues is used for performing bidirectional communication between the master node and the multiple worker nodes.

5. The method according to claim 4, wherein each two queues of the target number of queues are paired, and each pair of queues is used for performing bidirectional communication between the master node and one of the worker nodes; and, after creating a target number of queues based on the number of the worker nodes by the host process, the method further comprises:
by the host process, storing the target number of queues in the shared memory, and generating a queue storage address of each queue; and
by the host process, transmitting the queue storage address of each queue in the target number of queues to the master node, and transmitting the queue storage addresses of each pair of queues to a corresponding worker node; wherein the master node and each of the worker nodes communicate based on corresponding queue storage addresses.

6. The method according to claim 5, wherein each pair of queues comprises a first queue and a second queue, and the communication process of the master node with any one of the worker nodes comprises the following steps:
controlling the master node to, after encrypting first target data, write the encrypted first target data into the queue storage address of the first queue; and controlling the worker node to acquire the encrypted first target data in accordance with the queue storage address of the first queue; and/or
controlling the worker node to, after encrypting second target data, write the encrypted second target data into the queue storage address of the second queue, and controlling the master node to acquire the encrypted second target data in accordance with the queue storage address of the second queue.

7. The method according to claim 1, wherein the method further comprises:
by the host process, creating a thread pool for the master node and each of the worker nodes, respectively, wherein each thread pool comprises a preset number of threads; and
wherein the controlling the master node and each of the worker nodes to train a preset model by using corresponding respective decrypted sub-training data, respectively, to obtain a trained model comprises:
controlling the master node and each of the worker nodes to train the preset model based on the threads within a corresponding respective thread pool, respectively, to obtain the trained model.

8. The method according to claim 1, wherein the process of encrypting each piece of the sub-training data by the host process shares one symmetric key with the process of decrypting the encrypted sub-training data by each of the training nodes.

9. The method according to claim 4, wherein the master node and at least a portion of the worker nodes are distributed on different physical machines; and
the creating a target number of queues based on the number of the worker nodes by the host process, wherein the target number is twice the number of the worker nodes, comprises:
with respect to a target physical machine on which the master node is distributed, creating a target number of queues based on the number of the worker nodes on the target physical machine by the host process which is on the target physical machine, wherein the target number is twice the number of the worker nodes on the target physical machine; wherein the target number of queues is used for performing bidirectional communication between the master node on the target physical machine and multiple worker nodes on the target physical machine.

10. The method according to claim 9, wherein the method further comprises:
with respect to another physical machine on which the master node is not distributed, controlling the worker nodes distributed on the another physical machine to perform bidirectional communication with the master node on the target physical machine by adopting a Transmission Control Protocol (TCP).

11. An electronic device, comprising: a processor, a memory and a bus, wherein the memory stores machine-readable instructions executable by the processor, the processor and the memory communicate via the bus when the electronic device runs, and the machine-readable instructions, when executed by the processor, perform the following operations for model training:
by a host process, acquiring training data, and dividing the training data for a training node cluster employing a master-workers architecture to obtain multiple pieces of sub-training data; wherein the training node cluster comprises a master node and multiple worker nodes, which are used for performing model training in a collaborative manner; wherein the host process runs in a non-trusted execution environment, and the training node cluster runs in a trusted execution environment;
by the host process, encrypting each piece of sub-training data, and storing the encrypted sub-training data in a shared memory of the host process; wherein the shared memory of the host process is used for being shared by the host process and the training node cluster;
by the host process, recording a data storage address of each piece of the encrypted sub-training data in the shared memory, and transmitting respective data storage addresses to corresponding master node and worker nodes, respectively; wherein each data storage address corresponds to one training node;
controlling the master node and each of the worker nodes to acquire corresponding encrypted sub-training data from the shared memory in accordance with corresponding data storage addresses, respectively, and to decrypt the encrypted sub-training data to obtain decrypted sub-training data; and
controlling the master node and each of the worker nodes to train a preset by using corresponding respective decrypted sub-training data, respectively, to obtain a trained model; wherein during the training process, the master node is used for transmitting a training task to each of the worker nodes and for gathering sub-training results transmitted by the worker nodes.

12. The electronic device according to claim 11, wherein, after obtaining the multiple pieces of sub-training data corresponding to the number of the training nodes, the machine-readable instructions, when executed by the processor, further perform the following operations:
by the host process, activating the master node and each of the worker nodes, and controlling the master node and each of the worker nodes to generate, in accordance with a size of data volume of corresponding sub-training data, a trusted memory matched with the data volume, wherein the trusted memory is used for storing the sub-training data.

13. The electronic device according to claim 11, wherein the preset model is configured on the master node and each of the worker nodes, respectively; and the controlling the master node and each of the worker nodes to train a preset model by using corresponding respective decrypted sub-training data, respectively, to obtain a trained model comprises:
controlling the master node to assign a corresponding training task to each of the worker nodes based on the decrypted sub-training data corresponding to each of the worker nodes, and controlling the master node to transmit each training task to a corresponding worker node;
controlling each of the worker nodes to train the preset model in accordance with a corresponding training task and corresponding decrypted sub-training data to obtain a corresponding sub-training result;
controlling each of the worker nodes to transmit the corresponding sub-training result to the master node;
controlling the master node to gather the sub-training result of the master node and the sub-training results of the worker nodes to obtain a total training result; and
repeating the above steps until the total training result meets a preset condition.

14. The electronic device according to claim 11, wherein the machine-readable instructions, when executed by the processor, further perform the following operations:
by the host process, creating a target number of queues based on the number of the worker nodes, wherein the target number is twice the number of the worker nodes; wherein the target number of queues is used for performing bidirectional communication between the master node and the multiple worker nodes.

15. The electronic device according to claim 14, wherein each two queues of the target number of queues are paired, and each pair of queues is used for performing bidirectional communication between the master node and one of the worker nodes; and, after creating a target number of queues based on the number of the worker nodes by the host process, the machine-readable instructions, when executed by the processor, further perform the following operations:
by the host process, storing the target number of queues in the shared memory, and generating a queue storage address of each queue; and
by the host process, transmitting the queue storage address of each queue in the target number of queues to the master node, and transmitting the queue storage addresses of each pair of queues to a corresponding worker node; wherein the master node and each of the worker nodes communicate based on corresponding queue storage addresses.

16. A non-transitory computer-readable storage medium, wherein the computer-readable storage medium stores thereon a computer program which, when executed by a processor, causes the processor to perform the following operations for model training:
by a host process, acquiring training data, and dividing the training data for a training node cluster employing a master-workers architecture to obtain multiple pieces of sub-training data; wherein the training node cluster comprises a master node and multiple worker nodes, which are used for performing model training in a collaborative manner; wherein the host process runs in a non-trusted execution environment, and the training node cluster runs in a trusted execution environment;
by the host process, encrypting each piece of sub-training data, and storing the encrypted sub-training data in a shared memory of the host process; wherein the shared memory of the host process is used for being shared by the host process and the training node cluster;
by the host process, recording a data storage address of each piece of the encrypted sub-training data in the shared memory, and transmitting respective data storage addresses to corresponding master node and worker nodes, respectively; wherein each data storage address corresponds to one training node;
controlling the master node and each of the worker nodes to acquire corresponding encrypted sub-training data from the shared memory in accordance with corresponding data storage addresses, respectively, and to decrypt the encrypted sub-training data to obtain decrypted sub-training data; and
controlling the master node and each of the worker nodes to train a preset model by using corresponding respective decrypted sub-training data, respectively, to obtain a trained model; wherein during the training process, the master node is used for transmitting a training task to each of the worker nodes and for gathering sub-training results transmitted by the worker nodes.

17. The storage medium according to claim 16, wherein, after obtaining the multiple pieces of sub-training data corresponding to the number of the training nodes, the computer program which, when executed by the processor, causes the processor to further perform the following operations:
by the host process, activating the master node and each of the worker nodes, and controlling the master node and each of the worker nodes to generate, in accordance with a size of data volume of corresponding sub-training data, a trusted memory matched with the data volume, wherein the trusted memory is used for storing the sub-training data.

18. The storage medium according to claim 16, wherein the preset model is configured on the master node and each of the worker nodes, respectively; and the controlling the master node and each of the worker nodes to train a preset model by using corresponding respective decrypted sub-training data, respectively, to obtain a trained model comprises:
controlling the master node to assign a corresponding training task to each of the worker nodes based on the decrypted sub-training data corresponding to each of the worker nodes, and controlling the master node to transmit each training task to a corresponding worker node;
controlling each of the worker nodes to train the preset model in accordance with a corresponding training task and corresponding decrypted sub-training data to obtain a corresponding sub-training result;
controlling each of the worker nodes to transmit the corresponding sub-training result to the master node;
controlling the master node to gather the sub-training result of the master node and the sub-training results of the worker nodes to obtain a total training result; and
repeating the above steps until the total training result meets a preset condition.

19. The storage medium according to claim 16, wherein the computer program which, when executed by the processor, causes the processor to further perform the following operations:
by the host process, creating a target number of queues based on the number of the worker nodes, wherein the target number is twice the number of the worker nodes; wherein the target number of queues is used for performing bidirectional communication between the master node and the multiple worker nodes.

20. The storage medium according to claim 19, wherein each two queues of the target number of queues are paired, and each pair of queues is used for performing bidirectional communication between the master node and one of the worker nodes; and, after creating a target number of queues based on the number of the worker nodes by the host process, the computer program which, when executed by the processor, causes the processor to further perform the following operations:
by the host process, storing the target number of queues in the shared memory, and generating a queue storage address of each queue; and
by the host process, transmitting the queue storage address of each queue in the target number of queues to the master node, and transmitting the queue storage addresses of each pair of queues to a corresponding worker node; wherein the master node and each of the worker nodes communicate based on corresponding queue storage addresses.
